(19) United States
(12) Patent Application Publication
(10) Pub. No.: US 2006/0243689 A1
(43) Pub. Date: Nov. 2, 2006

(54) Decorative shelf

(75) Inventors: Malcolm K. Groff, Orwigsburg, PA (US); Gerhard Goehrig, Edingen (DE); Yeu-Tien Yu, Shin Dain City (TW)

Correspondence Address: Frank A. Mazzeo;Frank A. Mazzeo, P.C., Suite 200, 808 Bethlehem Pike, Colmar, PA, 18915, US

(73) Assignee: LTL Wholesale, Inc., Schuylkill Haven, PA (US)

(21) Appl. No.: 11/367,035

(22) Filed: Mar. 2, 2006

Related U.S. Application Data
(60) Provisional application No. 60/657,846, filed on Mar. 2, 2005.

(51) Int. Cl. A47F 5/08; A47G 29/087; A47F 5/00; B41M 5/00

(52) U.S. Cl. 211/90.01; 211/119.003; 428/195.1; 211/134; 211/115

(57) ABSTRACT

A decorative unit capable of being mounted to a wall is disclosed. The decorative unit may include a decorative portion mountable to a wall and a ledge extending therefrom. The decorative portion may be at least partially translucent. The decorative unit may include a light source behind the decorative portion capable of illuminating the decorative portion when on. A decorative unit may include a top surface capable of acting as a shelf and decorative sidewalls extending down therefrom. The decorative sidewalls may be at least partially translucent. The decorative unit may include a light source behind the decorative sidewalls capable of illuminating the decorative sidewalls when on. The decorative shelf may include molding where the decorative unit abuts the wall. The decorative shelf may include a bracket capable of being mounted to the wall and securing the decorative unit thereto.

### CROSS REFERENCE TO RELATED APPLICATION

This application claims priority from U.S. Provisional Application No. 60/657,846, filed on Mar. 2, 2005, which is incorporated herein by reference as if fully set forth.

### SUMMARY

One embodiment of a decorative shelf is disclosed that includes a decorative portion and a ledge extending therefrom. The decorative shelf may be capable of being mounted to a wall. The decorative portion may be a picture of illustration. The decorative portion may be made of glass, plastic or canvass. The decorative portion may be at least partially translucent. The decorative portion may include stained glass. The decorative portion may include a frame therearound. The ledge may extend substantially perpendicular to the decorative portion and may be capable of holding objects thereon. The ledge may be made of glass. The decorative shelf may further include a light source behind the decorative portion capable of illuminating the decorative portion when on.

One embodiment of a decorative shelf is disclosed that includes a top surface capable of acting as a shelf and decorative sidewalls extending down therefrom. The decorative sidewalls made of glass, plastic or canvass. The decorative sidewalls may be at least partially translucent. The decorative sidewalls may include stained glass. The decorative shelf may further include a light source behind the decorative sidewalls capable of illuminating the decorative sidewalls when on. The decorative shelf may further include a bottom surface. The decorative shelf may include molding along the top and/or bottom surfaces where the top and/or bottom surfaces abut the wall. The decorative shelf may include a bracket capable of being mounted to the wall and securing the decorative shelf thereto.

A bracket is disclosed that includes a back surface having holes formed therein for screwing into a wall. The bracket may include flanges extending from the back surface for supporting a decorative piece (shelf, light). The bracket may include edges and flanges forming channels that can support a decorative piece. The bracket may include molding mounted on the edges thereof of a connection mechanism for enabling mounting of molding thereto. The bracket may further include clasps for securing a light source thereto, the light source being capable of illuminating a decorative piece attached thereto.

### BRIEF DESCRIPTION OF THE DRAWINGS

The features and advantages of the various embodiments will become apparent from the following detailed description in which:

FIG. 1 is a front elevational view of an example decorative shelf, according to one embodiment;

FIG. 2 is a side elevational view of an example decorative shelf, according to one embodiment;

FIG. 3 is a perspective view of an example decorative shelf, according to one embodiment;

FIG. 4 is a front elevational view of an example decorative shelf with decorative panel removed, according to one embodiment;

FIG. 5 is a perspective view of an example decorative shelf, according to one embodiment;

FIG. 6 is a perspective view of an example decorative shelf, according to one embodiment;

FIG. 7 is a perspective view of an example decorative shelf, according to one embodiment;

FIG. 8 is a perspective view of an example decorative shelf, according to one embodiment;

FIG. 9 is a perspective view of an example decorative corner shelf, according to one embodiment;

FIG. 10 is a front view of an example bracket, according to one embodiment; and

FIG. 11 is a perspective view of an example bracket, according to one embodiment.

### DETAILED DESCRIPTION

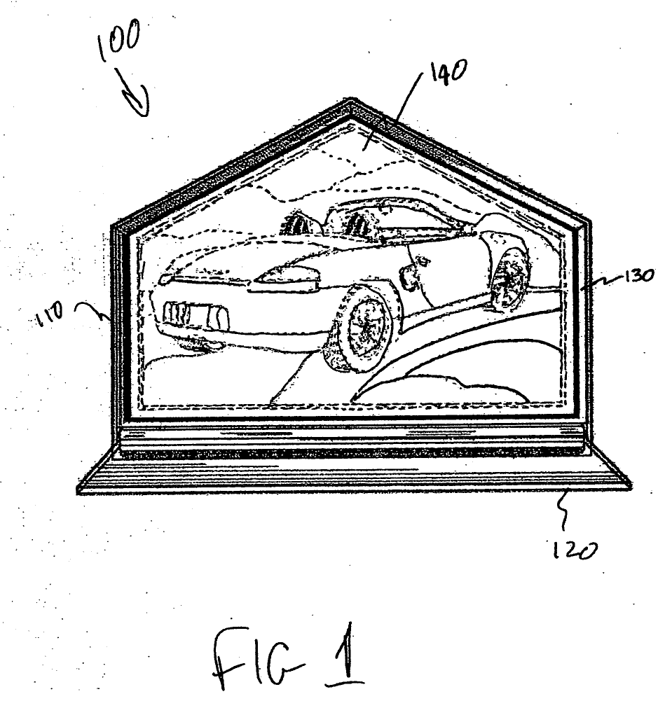

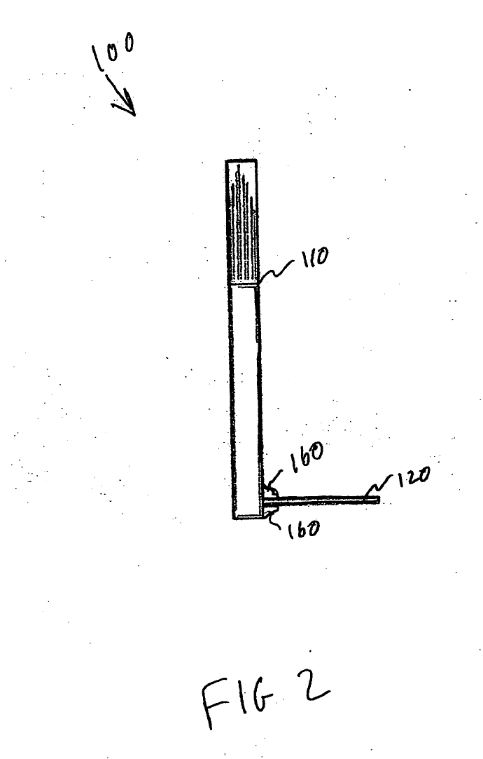

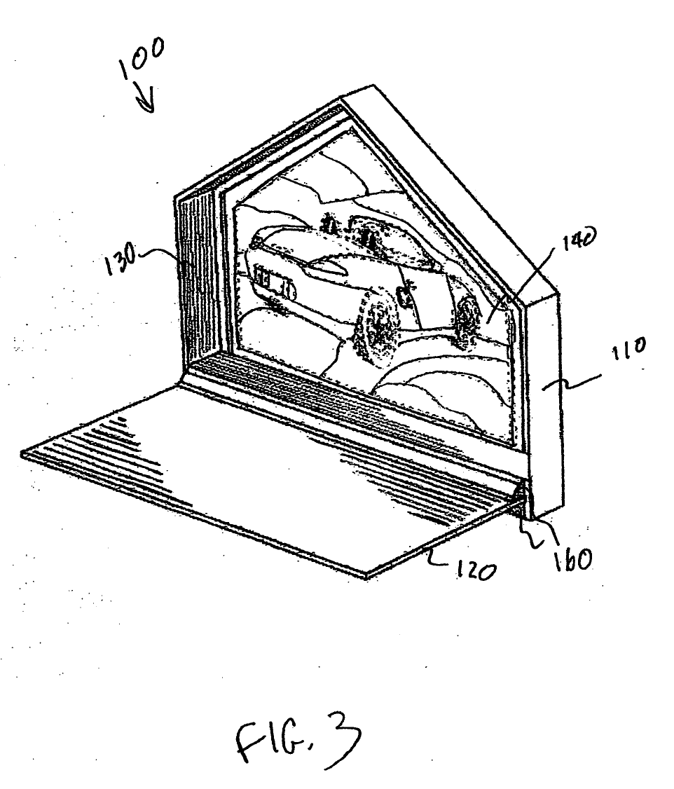

FIGS. 1-3 illustrate front, side and perspective views of an example decorative shelf 100. The shelf 100 may be mountable to a wall. The shelf 100 may include a decorative portion 110 and a ledge 120 extending from the decorative portion 110 at substantially a ninety degree angle. The decorative portion 110 may lay against the wall so that the ledge extends substantially perpendicular thereto. The ledge 120 may be capable of holding items thereon.

The decorative portion 110 may be a picture or illustration. The decorative portion 110 may include stained glass. The decorative portion 110 may be a mirror. The decorative portion 110 may be at least partially translucent. The decorative portion 110 may include a frame 130 and a decorative panel 140 as a front wall of the frame 130. The decorative panel 140 may be made of glass, plastic or canvass. The frame 130 may be made of wood, plastic or metal. The frame 130 may simply enclose the decorative panel 140 or may be decorative (e.g., molding).

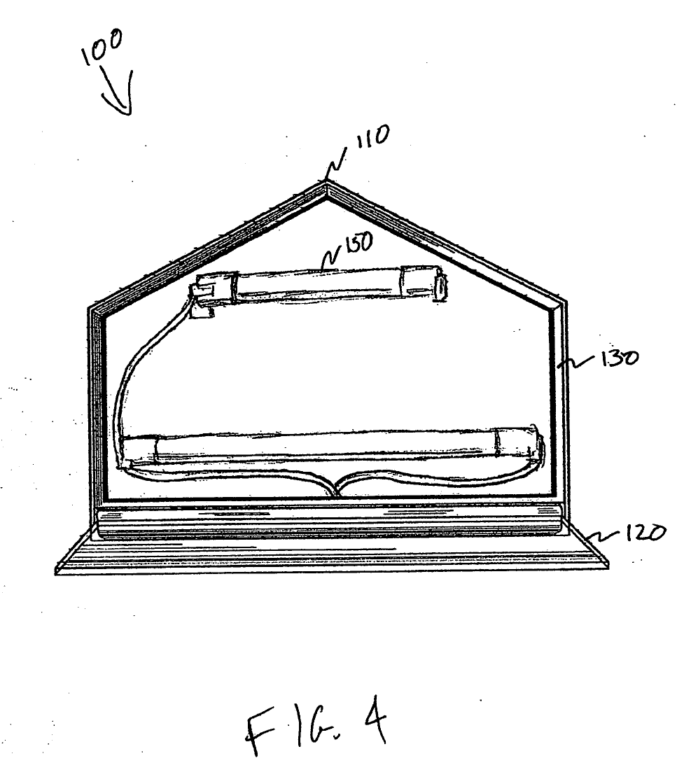

FIG. 4 illustrates a front view of an example decorative shelf 100 with the decorative panel 140 removed. The decorative portion 110 may also include a light source 150 within the frame 130 behind the decorative panel 140 so that when turned on the light source illuminates the decorative panel 140. The light source may be light bulbs (incandescent, florescent) or may be light emitting diodes (LEDs) or other known light sources. The light source 150 may be battery operated or may include a cord and plug that can be connected to a power supply (e.g., outlet).

The plug may be mounted to the back of the decorative shelf 100 so that it can be plugged directly into an outlet that would be behind the decorative shelf 100 when the decorative shelf 100 was hung. If the plug is mounted to the back of the decorative panel it may be movable along the back and the prongs of the plug may be able to be retracted. The cord may extend from the decorative shelf 100 so that the plug can be connected to the closet outlet. The cord may be a retractable cord so that any excess cord is hidden within the frame 130. The decorative shelf 100 may include decorative covers or other means to hide the cord extending therefrom.

As illustrated in FIGS. 1-4, decorative portion 110 is five sided but is in no way limited thereto. Rather the decorative portion 110 could be any size or shape without departing from the scope.

The ledge 120 may be permanently mounted to the decorative portion 110 or may be removably connected to the decorative portion 110. The ledge 120 may be configurable with respect to the decorative portion 110 (e.g., moved to the left or right, move up or down, change angle). The ledge 120 may be made of a solid material (e.g., wood, plastic) or may be made of a translucent material (e.g., glass). The ledge 120 may simply be decorative, may be designed to simply hold ornamental decorations (e.g., support a few pounds) or may be designed to support items having at least some substantial weight (e.g., support 10 pounds or more). The ledge 120 may me connected at an edge of the decorative portion 110 or may be inset from the edge.

The decorative portion 110 may include strips (e.g., molding) 160 protruding therefrom that the ledge 120 can be inserted into. The strips 160 may also provide support for holding the ledge 120.

The decorative portion 110 may be substantially above the ledge 120 as illustrated in FIGS. 1-4 but is not limited thereto. Rather, the ledge 120 may be placed on different locations (e.g., at the top of the decorative portion 110 so that the decorative portion 110 is below the ledge 120) or multiple ledges may be included at various points on the decorative portion 110 (e.g., top and bottom). FIGS. 1-4 also illustrate ledge 120 being a rectangle but it is clearly not limited thereto. Rather the ledge 120 could be any size or shape without departing from the scope.

The decorative shelf 100 may be secured to a wall by placing screws or nails into the wall and hanging the decorative shelf 100 from the screw or nails. The decorative shelf 100 may include holes in the frame 130 that the screws or nails can fit into, may include a wire hanging from the back of the decorative shelf 100 that can be draped over the screws or nails, or may include a back face (not illustrated) that can be directly screwed into the wall and then the remainder of the decorative shelf 100 can be connected thereto. The decorative shelf 100 may be connected to the back face using some type of connection or latching mechanism.

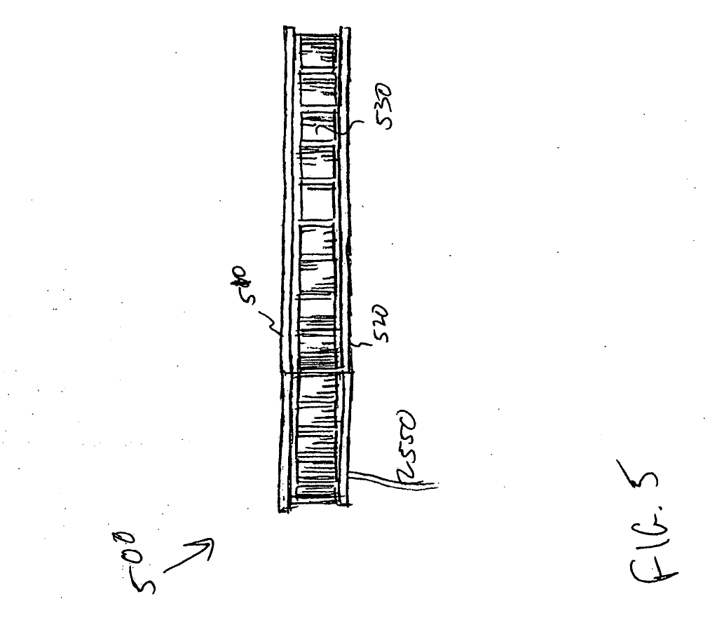

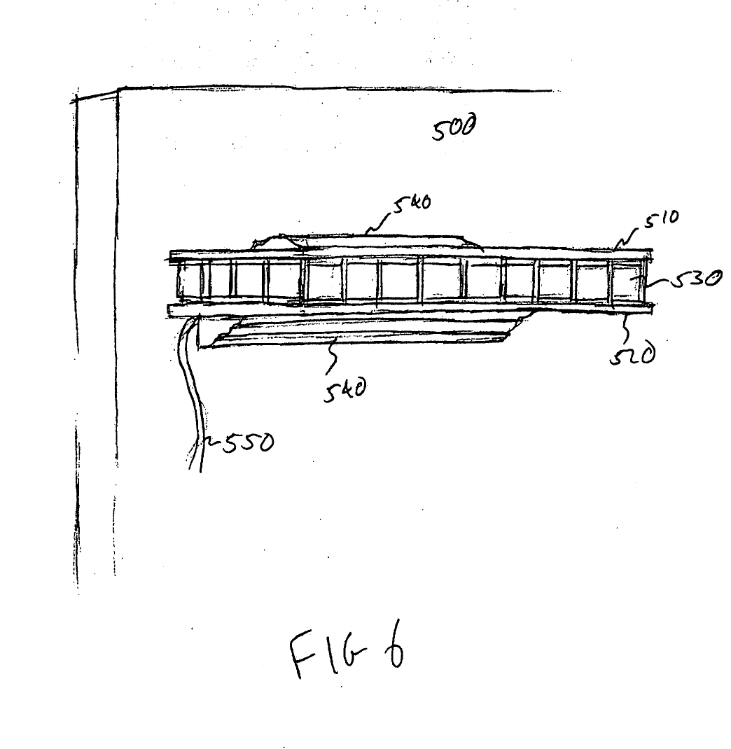

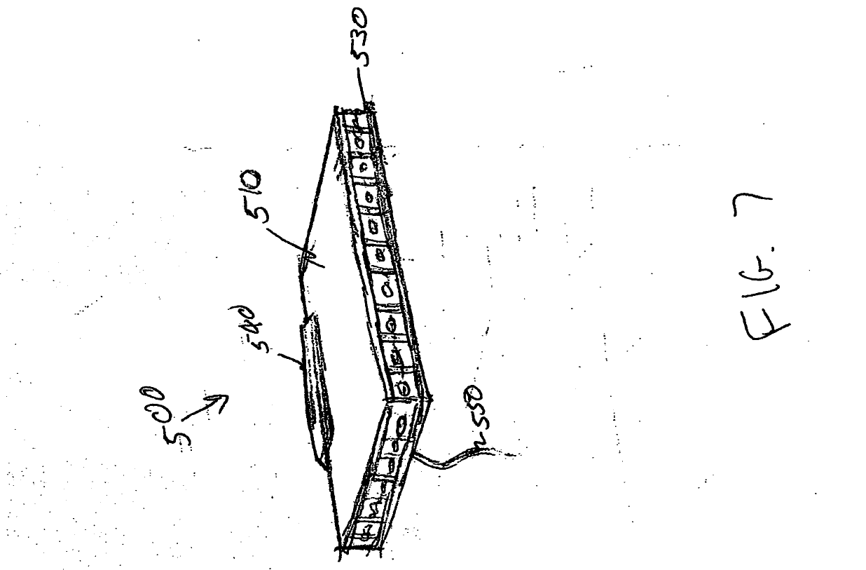

FIGS. 5-9 illustrate perspective views of an example decorative shelf 500. The decorative shelf 500 includes a top 510 and a bottom 520 and sidewalls 530 connecting the top 510 and the bottom 520. The top 510 may be made of a solid material (e.g., wood, plastic) or may be made of a translucent material (e.g., glass). The top 510 may be designed to simply hold ornamental decorations (e.g., support a few pounds) or may be designed to support items having at least some substantial weight (e.g., support 10 pounds or more). The top 510 and the bottom 520 may be solid or may be at least partially translucent. The top 510 and the bottom 520 may be decorative. The sidewalls 530 may be decorative. The sidewalls 530 may include stained glass. The sidewalls 530 may be at least partially translucent. The sidewalls 530 may be made of glass, plastic or canvass.

The decorative shelf 500 may include molding 540 along the top and/or bottom. The decorative shelf 500 may include a light source (not illustrated) therewithin so that when turned on the light source illuminates the shelf 500 (at least the sidewalls 530 and possibly the top 510 and/or the bottom 520). The light source may be light bulbs (incandescent, florescent) or may be light emitting diodes (LEDs) or other known light sources. The light source may be battery operated or may include a cord 550 and plug (not illustrated) that can be connected to a power supply (e.g., outlet).

The plug may be mounted to the back of the decorative shelf 500 so that it can be plugged directly into an outlet that would be behind the decorative shelf 500 when the decorative shelf 500 was hung. If the plug is mounted to the back of the decorative shelf 500 it may be movable along the back and the prongs of the plug may be able to be retracted. The cord 550 may extend from the decorative shelf 500 so that the plug can be connected to the closet outlet. The cord 550 may be a retractable cord so that any excess cord is hidden within the decorative shelf 500. The decorative shelf 500 may include decorative covers or other means to hide the cord 550 extending therefrom.

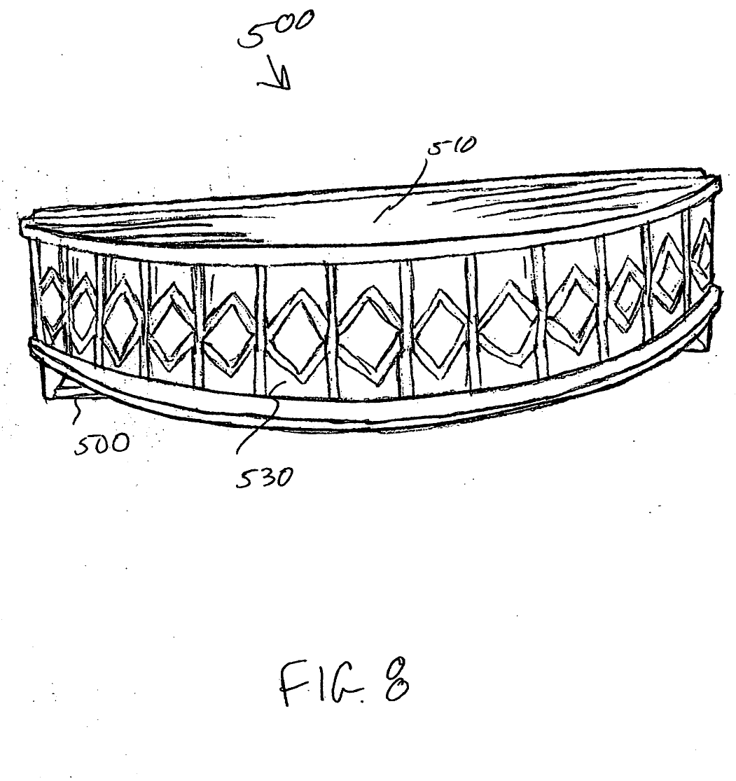

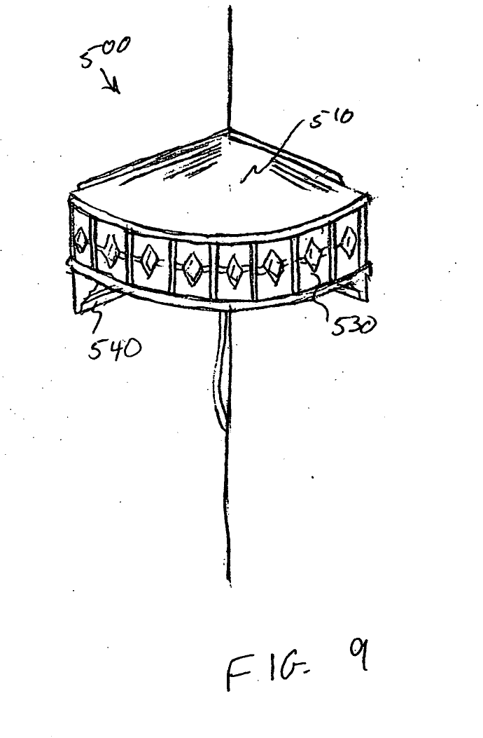

FIGS. 5-7 illustrate the decorative shelf 500 as rectangular but it is in no way limited thereto. Rather, the decorative shelf 500 could be any size or shape without departing from the current scope. For example, FIG. 8 illustrates the decorative shelf 500 being a semi-circle. FIGS. 5-8 illustrate the decorative shelf 500 that is mountable on a single wall but is in no way intended to be limited thereto. For example, FIG. 9 illustrates the decorative shelf 500 being a corner shelf having a quarter circle shape, but the shape is not limited thereto as it could be any shape (e.g., square, rectangle, triangle).

The decorative shelf 500 need not be used as a shelf at all it could be used as a wall decoration or in the embodiment including a light source could be used as a wall light fixture. The decorative shelf 500 could be mounted or connected to a decorative portion (e.g., 110 of FIGS. 1-3). The decorations on the sidewalls 530 could be coordinated with the decorations on the portion.

The decorative shelf 500 may be secured to a wall by placing screws or nails into the wall and hanging the decorative shelf 500 from the screw or nails. The decorative shelf 500 may include holes in the top 510 or the bottom 520 that the screws or nails can fit into, may include a wire hanging from the back of the decorative shelf 500 that can be draped over the screws or nails, or may include a back face (not illustrated) that can be directly screwed into the wall and then the remainder of the decorative shelf 500 can be connected thereto. The decorative shelf 500 may be connected to the back face using some type of connection or latching mechanism.

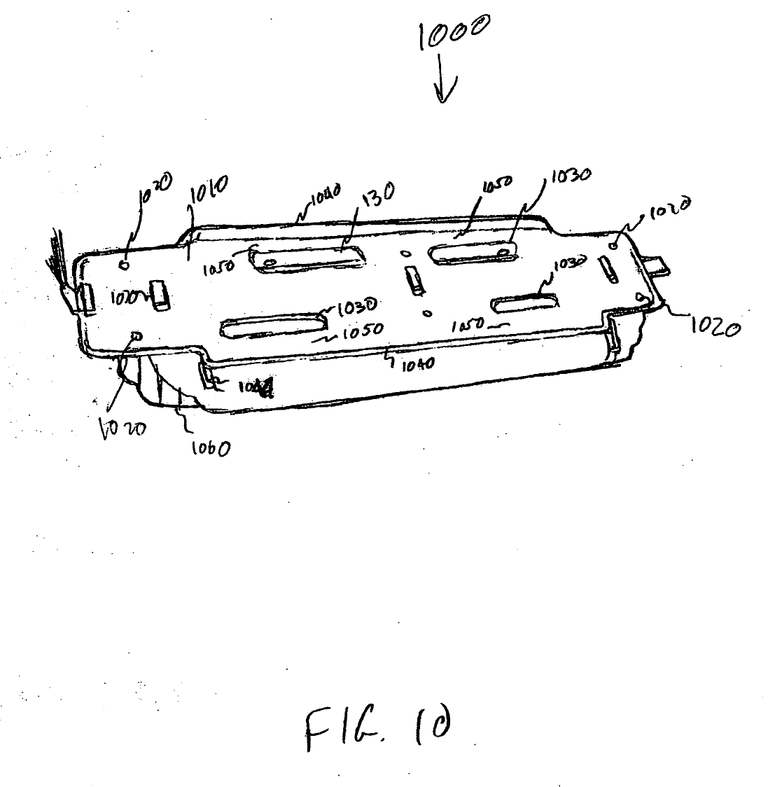

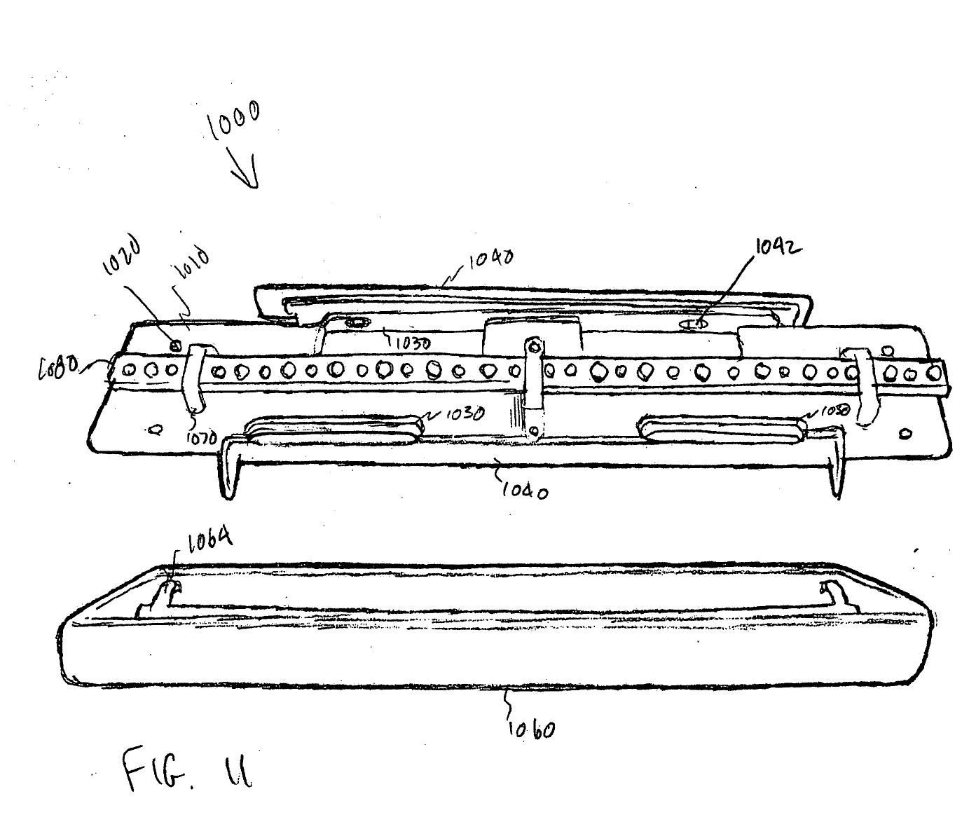

FIGS. 10 and 11 illustrate front and perspective views of an example bracket 1000 that can be used to secure a decorative piece, decorative shelf or decorative light fixture (e.g., decorative shelf 500) to the wall. The bracket 1000 may be made of a sturdy material (e.g., wood, plastic, metal). The bracket 1000 may include a back surface 1010 that is mountable to the wall. The back surface 1010 may include holes 1020 formed therein for screwing the bracket 1000 to the wall. The bracket 1000 may include flanges 1030 extending substantially perpendicular to the back surface 1010. The flanges 1030 may be used to connect to the decorative piece/shelf/light fixture. The flanges 1030 may fit into groves formed in a back edge of the top and bottom of the decorative piece/shelf/light fixture. The bracket 1000 may include top and bottom edges 1040 extending substantially perpendicular to the back surface. The combination of the flanges 1030 and the edges 1040 may create channels 1050 that can receive the top and the bottom of the decorative piece/shelf/light fixture.

In order to hide the edges 1050 of the bracket 1000 pieces of molding 1060 may be attached thereto. The molding 1060 may be permanently attached to the bracket 1000 (e.g., with glue) or may be removably attached thereto using any number of connection mechanisms. For example, the molding 1060 may be may include stubs (not illustrated) that can be inserted through holes 1042 in the edges 1040. Alternatively, the edges 1040 may have flanges 1044 extending therefrom that can be inserted in grooves 1064 formed in the molding 1060.

The bracket may further include clasps 1070 on the portion 1010 that can be used to hold a light source 1080. As illustrated the light source is a strip of LEDs but is in no way limited thereby.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A decorative shelf capable of being attached to a wall, the shelf comprising
a decorative portion; and
a ledge connected to the decorative portion.

2. The shelf of claim 1, wherein the decorative portion is at least partially translucent.

3. The shelf of claim 1, wherein the decorative portion is stained glass.

4. The shelf of claim 1, further comprising a light source behind the decorative portion.

5. The shelf of claim 4, wherein the light illuminates the decorative portion when lit.

6. The shelf of claim 1, further comprising molding on at least one side of the decorative portion where the ledge and the decorative portion meet.

7. The shelf of claim 1, wherein the ledge extends substantially perpendicular to the decorative portion.

8. The shelf of claim 1, wherein the decorative portion abuts a wall that the shelf is mounted to.

9. The shelf of claim 1, wherein the ledge is a top surface of the shelf and the decorative portion extends down from an exterior edge of the ledge.

10. The shelf of claim 9, further comprising molding on at least one side of the ledge where the ledge and a wall meet.

11. A unit connectable to a wall, the unit comprising:
a top portion; and
decorative sidewalls extending down from an exterior edge of the top portion.

12. The unit of claim 11, wherein the top portion is a shelf.

13. The unit of claim 11, wherein the decorative sidewalls are translucent.

14. The unit of claim 11, wherein the decorative sidewalls are stained glass.

15. The unit of claim 11, further comprising a light source behind the decorative sidewalls to illuminate the sidewalls when lit.

16. The unit of claim 11, further comprising a bracket mountable to the wall and capable of supporting the top portion and the sidewalls extending therefrom.

17. The unit of claim 11, wherein the top portion and the decorative sidewalls are a single unit.

18. A bracket capable of being mounted to a wall and supporting a decorative unit, the bracket comprising
a backwall having holes formed therein for receiving screws to mount to a wall;
flanges extending from the backwall and capable of receiving edges of a decorative unit and supporting the decorative unit; and
clasps to hold a light source capable of illuminating the decorative unit when activated.

19. The bracket of claim 18, further comprising edges extending from the backwall when the flanges and the edges form a groove for receiving edges of the decorative unit.

20. The bracket of claim 18, further comprising molding mountable to edges thereof.
